(19) United States
(12) Patent Application Publication
(10) Pub. No.: US 2016/0144882 A1
(43) Pub. Date: May 26, 2016

(54) Para-Alpine sit-ski seat rises and tilts to permit handicapped skiers to assume seating in standard ski slope chair lifts, unassisted if needs be

(71) Applicants: Steve Holub, El Cajon, CA (US); Kevin McKee, Hemet, CA (US)

(72) Inventors: Steve Holub, El Cajon, CA (US); Kevin McKee, Hemet, CA (US)

(21) Appl. No.: 14/544,103

(22) Filed: Nov. 24, 2014

(51) Int. Cl. B62B 17/06

(52) U.S. Cl. CPC B62B 17/063

(57) ABSTRACT

A para-alpine ski, typically a dual-runner sit-ski, has a seat and undercarriage that a user/skier can—under no force(s) save his/her own—cause to raise to a height sufficient so as to permit boarding—totally unassisted if needs be—of the user-skier and his/her entire para-alpine ski onto a moving carry chair of a standard ski-slope chair lift. Upon disembarking the ski slope chair lift the user-skier can lower his/her seat for skiing, again without assistance. When the same sit-ski is used to ferry a total invalid then a trained instructor or guide who normally stands at, and steers from, the back of the sit-ski can stand alongside the sit-ski and its occupant at the point of loading the chair lift, and can trigger the sit-ski seat and its occupant to rise, again permitting that the chair of a standard ski-slope chair lift may be adroitly mounted.

### REFERENCE TO RELATED APPLICATIONS

The present application is related to co-pending U.S. patent applications Ser. Nos. A,AAA,AAA for a REMOVABLE/REPLACEABLE WHEELCHAIR BUMPER and B,BBB,BBB for a WHEELCHAIR WITH MULTIPLE REPLACEABLE SEATS and C,CCC,CCC for a PARA-ALPINE SIT-SKI WITH INDEPENDENTLY QUICK-DETACHABLE AND RE-ATTACHABLE (1) OUTRIGGER SKIS, AND/OR (2) A “ROLL BAR” FOR GUIDANCE to the selfsame inventors as, and filed on an even date with, the present application. The contents of the related patent applications are incorporated herein by reference.

### BACKGROUND OF THE INVENTION

1. Field of the Invention

The present invention generally concerns equipment for handicapped para-alpine and para-lympic skiers: namely, skis, and most commonly skis of the sit-ski type having dual runners. (This equipment can be, and is, also used by able-bodied skiers.)

The present invention particularly concerns a para-alpine type ski, most commonly a two-runner sit-ski, having a seat that controllably (1) rises in height and (2) tilts, or pivots, so as to permit the sit-ski occupant to, among other things, assume at a loading station a seat upon a lift chair of a standard ski lift; all totally unassisted if needs be.

2. Background of the Invention

2.1 Para-Alpine Skiing

In the entry “Para-alpine skiing” appearing at Wikipedia, the free encyclopedia of the Internet, circa February, 2013, it is explained that “[p]aralympic alpine skiing is an adaptation of alpine skiing for athletes with a disability. The sport evolved from the efforts of disabled veterans in Germany and Austria during and after the Second World War. The sport is governed by the International Paralympic Committee Sports Committee. The primary equipment used includes outrigger skis, sit-skis, and mono-skis. Para-alpine skiing disciplines include the Downhill, Super-G, Giant Slalom, Slalom, Super Combined and Snowboard.

“Para-alpine skiing classification is the classification system for para-alpine skiing designed to insure fair competition between alpine skiers with different types of disabilities. The classifications are grouped into three general disability types: standing, blind and sitting. A factoring system was created for para-alpine skiing to allow the three classification groupings to fairly compete against each other in the same race despite different functional skiing levels and medical issues.

“Alpine skiing was one of the foundation sports at the first Winter Paralympics in 1976 with Slalom and Giant Slalom events being held. Different disciplines were added to the Paralympic program over time. The 2010 Winter Paralympics para-alpine skiing events were held at Whistler Creekside. The disciplines at Whistler included Downhill, Super-Combined, Super-G, Slalom and Giant Slalom.”

2.2 Para-Alpine Skiing Equipment

Also in the Wikipedia entry it is explained that “[t]he primary equipment used in the [para-alpine skiing] sport includes outrigger skis, sit-skis, and mono-skis. Depending on the classification, other equipment may be used by skiers including guide skiers, cut-down ski poles, orthopedic aids, or prostheses. For skiers with visual impairments, guides are used to assist the skier down the course . . . . Rules for equipment use in competition are set by FIS and the IPC.

“There are minimum lengths for skis used in competition, with men's skis needing to be at least 165 centimeters (65 in) long and women's skis needing to be at least 155 centimeters (61 in) long. Bindings used for skis have a maximum height of 55 millimeters.

“Sit-skis are designed for wheelchair users or other skiers with a form of paraplegia. The first sit-ski was built in 1967 by Josef Shrall from the Bavaria region of Germany. Early sit-skis used in para-alpine skiing had two wide skis, brakes, and were custom built to fit the specific skier. The weight of the ski prevented skiers from skiing moguls or steep slopes. Sit-ski development continued into the 1980s, with a more modern version demonstrated in Engelberg, Switzerland in 1987 at a workshop hosted by the Swiss Association of Paraplegics. As the technology advanced, a chair was developed that could be attached to the skis which were used by able bodied skiers. They are now made from fiberglass and polyester, and the weight has been dramatically reduced, allowing skiers to ski on steeper slopes and compete in the moguls. Current sit-skis include seat-belts. As skis for able-bodied skiers have evolved to specialize for the event, the skis that sit-skiers use have also changed.

“Sit-skiers use a specially designed ski called a mono-ski, sometimes called a maxi mono-ski. It is used by skiers with lower limb disabilities including paralysis. A variation of the mono-ski exists for skiers with bilateral, above the knee amputations. The mono-ski was developed in Austria in the early 1980s by bilateral above-the-knee amputee Josef Feirsinger and engineer Horst Morokuti. The fundamental design they created is still the one used for mono-skis currently used in competition. The mono-ski was quickly used by German skiers who built their own at a workshop in Tübingen. The mono-ski uses the same skis used for able-bodied alpine skiing, adapted so that the skier sits on a chair attached to the ski via a spring. The mono-ski was first used at the 1988 Winter Paralympics.”

2.3 The Problem Addressed by the Present Invention

Para-alpine sit skis with either one and two runners are exceedingly ineffective, and cumbersome, when the skier must assume a chair upon a standard ski lift.

The present process generally requires that (1) the sit-skier have a complete and strong upper torso and arms to manipulate two outrigger skis held one each in the two arms and hands, plus (2) a quite strong (full bodied) assistant skier positioned to either side of the sit skier. When it is time for the sit skier to get on a chair of a normally operating ski slope chair lift (1) all three persons must first timely assume position with even more than attentiveness and agility than a conventional skier, sit-skier in the middle, and then (2) when the chair comes (and not appreciably before and certainly not after) the two persons on either side of the sit-skier must lift him/her and his/her sit ski into the chair in one huge lift, (3) everybody (all three persons) getting onto the ski lift chair.

To say that this is difficult, and tricky, is an understatement. Absolutely everything must be done with precision, and strong force. Worst of all, the para-alpine skier—who may be an exceedingly excellent skier on the slopes—is essentially helpless to assume the ski lift on his or her own behalf, and is essentially nearly totally dependent upon others in a most public of places. Many para-alpine skiers regard this operation of getting onto the chair of a standard chair lift to be a frustrating and awkward—and occasionally humiliating—experience demanding of more support and attention than many para-alpine skiers either want or enjoy.

Notably even if the Para-alpine skier has a skiing companion, such as a spouse, this person may not be strong enough to perform a support role aside the para-alpine skier during entrance onto a moving lift chair, nor even it he/she is both so sufficiently strong and willing, still another person is needed. Although such a second person can sometimes be “drafted” from among abundant willing skiers, to do so is dangerous. This is because no matter how many times explained, and at what level of detail, timing in lifting the para-alpine skier and his/her ski(s) onto the chair of the chair lift is everything, and the consequences of not doing the task exactly correctly can be dire.

The present invention will be seen to solve this considerably “knotty”, and involved, problem by permitting a para-alpine skier to, if necessary, mount the chair of a moving ski slope chair lift totally without assistance. The para-alpine skier is, however, normally accompanied by at least one person positioned to at least one side for purposes of stabilization, and of helping the para-alpine skier maintain left-right balance. Notably, this person can be an untrained and unskilled stranger so long as willing, stalwart, and totally familiar with mounting chair lifts; this person being required only to get himself/herself into the chair while potentially being willingly touched—generally only but lightly—on the arm or on the shoulder.

### SUMMARY OF THE INVENTION

The present invention contemplates an improvement to existing single-runner (monoski) and double-runner (sit-ski) para-alpine skis so that a user—most often a paraplegic or amputee—seated upon a seat of the para-alpine ski can controllably cause the ski seat to (1) rise, and also to (2) tilt, so as to permit the skier-user still upon his/her (now elevated and tilted) seat, and the entire para-alpine ski, to assume a normal seat upon a lift chair of a conventional ski slope chair lift; all totally without assistance if needs be.

The present invention deals with a considerable obstacle to the full enjoyment of skiing by skiers who are handicapped in a manner so that they must sit upon their skis. These sit-down skis—whether of the single-runner (monoski) or dual-runner (sit-ski) types, and substantially regardless of the particular disability of the user-occupant of the ski—have proven manifestly unsuitable to permit the user-occupant to gracefully assume a seat upon a conventional chair lift, if at all. Normally the disabled skier seated upon his/her para-alpine ski must be centered at a ski lift boarding station between two strong persons also wearing skis. When a chair of the chair lift approaches, these two strong persons must lift the handicapped skier and all his/her equipment situated between them onto the chair of the ski lift while also boarding the same chair themselves—no mean feat of either strength or coordination. Thus, while para-alpine skiing equipment improves, and while para-alpine skiers increase in numbers (without growth in eligible populations resultant from war), and while para-alpine skiers improve in their skills and set new competition performance records, the loading of even a championship para-alpine (para-lympic) skier onto a conventional ski slope chair lift remains an awkward and a difficult event.

1. A Para-Alpine Sit-Ski Having a Raising and Tilting Seat

Accordingly, in one of its aspects the present invention is embodied in a para-alpine ski having a seat upon which sets a user/skier, this para-alpine ski being characterized in that the user/skier is able to permit the seat to raise—optionally under no force save the skier's own—to a height sufficient so that a carry chair of a standard ski-slope chair lift can slip comfortably under the seat of the ski, and under the user who remains seated upon the seat—therein to capture the seat, the seated user and the entire para-alpine ski onto the ski-lift chair and to further convey both the user/skier and the para-alpine ski up a ski slope. By this operation the user/skier of this raising-seat para-alpine ski can assume a position seated upon an operating conventional ski slope ski-lift totally without external assistance from other humans or other machines if needs be. (Assistance if provided goes generally to stability and guidance, and not to any lifting.)

Importantly to the gracefulness and certainty of this capability of and for a para-alpine skier and his/her para-alpine ski to assume a seated position upon the moving chair of a ski-slope chair lift, the elevated seat of the para-alpine ski can pivot in a substantially vertical plane substantially longitudinally bisecting the para-alpine ski and its occupant para-alpine skier. This is because a slight tilting motion attends the position of the buttocks of any person mounting the chair of a ski-slope chair lift, although most persons so acting pay no attention to their motional mechanics, and, indeed, do not even recognize that they, and their buttocks, undergo this motion. Essentially this slight tilting motion is performed when any skier mounting the lift chair of a chair lift “sits back”, and assumes a seated position upon the (moving) chair. So also does the “tilt” of the seat of the para-alpine ski of the present invention permit of this natural, and effective, motion. Notably, when the para-alpine ski is in use for skiing, it is not desired (for reasons of stability, and feel) that its seat should tilt, pivot, or be anything but firmly attached and positionally registered to the frame of the para-alpine ski. This is ultimately like as to the fact that the posterior of a conventional skier is certainly in firm relationship to the skis via the skiers legs during skiing, and does not “flop” or otherwise move left and right, nor fore and aft. So also is the seat of the para-ski freed for tilting—howsoever minor—only when elevated, remaining positionally and rotationally and attitudinally fixed to the fame of the para-ski when in its “down” position for skiing.

The mechanism serving to raise the seat of the para-alpine ski (upon which seat sets the user/skier) is preferably adjustable in the force that it provides to raise both itself and the user/skier.

The para-alpine ski can be (1) of the sit-ski type, with two ski runners or (2) of the mono-ski type, with a single ski runner. The para-alpine sit-ski may optionally mount detachable and re-attachable outrigger runners to either, or to both, sides. These runners provide stability and control, especially to (1) less-expert skiers, and/or (2) to skiers whose disabilities may not be symmetric about an imaginary vertical longitudinal central plane of the para-alpine sit-ski.

In summary the engineering of a para-alpine ski in accordance with the present invention might be found to be straightforward, but is arguably also elegant and refined. Namely, a para-alpine ski is modified not merely so that it may be “wrenched”, or “snatched”, onboard the moving chair of a ski lift, but so that the entire operation may be performed with a modicum of certainty, smoothness, and grace.

2. A Para-Alpine Ski with an Elevating and Tilting Seat

In another of its aspects the present invention is embodied in a para-alpine ski including (1) at least one ski runner; (2) a seat upon which sets a user/skier; and (3) a spring mechanism, pre-loaded to the substantial weigh of the user/skier and located between the at least one ski runner and the seat, controllable by the user/skier to elevate the seat and the user/skier upon the seat in elevation sufficient so that a carry chair of a standard ski-slope chair lift can slip under the seat, and under the user who remains seated upon the seat, therein to permit that the seat, the seated user and the entire para-alpine ski can be captured onto the moving chair a ski-lift chair and may be further conveyed up a ski slope. Resultant to this co-action, the user/skier of this raising-seat para-alpine ski can assume a position seated upon an operating conventional ski slope ski-lift without external assistance from other humans or other machines if needs be.

The spring mechanism is preferably enhanced and extended to incorporate a gas-charged spring much the manner of the elevating of the rear hatches of some sport utility vehicles. This spring, and its attachment at each of its two ends to different parts of the frame of the para-ski, is what permits the desirable upwards extension and tilting and raising of the upper frame including the seat, and the sit-ski occupant who sits upon the seat. The raising and tilting is sufficient so that a chair of a ski lift will pass into the void under the raised upper frame and seat until, not being able to progress further to the forward against the frame of the sit-ski, will capture the complete sit-ski and its occupant, and carry all up a ski slope in a conventional manner.

The gas-charged spring mechanism serving to raise the seat of the ski upon which sets the user/skier is preferably adjustable in its force so provided to raise the seat, and the user/skier who is upon the seat.

The para-alpine ski can be of the sit-ski type, with two ski runners or of the mono-ski type, with a single ski runner. It may optionally be possessed of auxiliary, outboard, outrigger runners to either, or to both, sides. The optional outrigger skis are part of the lower frame, and, along with the lower frame and its skis, are not involved in the upwards extension, tilting and lifting action of the upper frame and its seat.

These and other aspects and attributes of the present invention will become increasingly clear upon reference to the following drawings and accompanying specification.

### BRIEF DESCRIPTION OF THE DRAWINGS

FIG. 1 is a frontal perspective view of a preferred embodiment of the present invention as a two-runner sit-ski with optional outrigger runner skis to both sides, the sit-ski being shown in its “down” position as is used by a paraplegic or like disable person for skiing downhill.

FIG. 2 is a perspective view of the same preferred embodiment of the present invention as a two-runner sit-ski previously seen in Figure, now without optional outrigger skis for clarity in the view, and now shown in its “up” position as the bi-ski assumes for entering onto and for riding upon, a standard chair of a standard ski-slope chair lift.

FIG. 3 is exploded perspective view of the same preferred embodiment of the present invention as a two-runner sit-ski, sans optional outrigger skis, that was previously seen in FIG. 2.

### DESCRIPTION OF THE PREFERRED EMBODIMENT

1. Terminology

The present invention of (1) a mechanism permitting handicapped skiers to assume seating in standard ski slope chair lifts—unassisted if needs be—and of (2) para-alpine skis incorporating this mechanism, will be taught in the context of a dual-runner para-alpine sit-ski with optional outrigger skis. The invention is equally applicable to (1) single-runner mono-skis, and to (2) skis and to personal ski sleds and the like, that may have three and even more runners. Therefore when the term “para-alpine ski” is used in this specification it should be interpreted broadly, and not just in the context of alpine or downhill skiing, and not just in the context of any single mono-ski, sit-ski, or other ski for handicapped skiing.

Occupants of para-alpine skis in accordance with the present invention may have diverse forms of full or partial paralysis (paraplegics), and/or of limb amputation (amputees). Where called for the specification should be interpreted to show a universal lift mechanism adaptable to circumstances. For example, when a latch is described to be activated by the right hand of the user, than it may also be adapted to be activated by the left hand of the user, mutatis mutandis.

Further, the person using a para-alpine ski in accordance with the present invention may variously at times, and from time to time (as context dictates) be called a “user”, an “occupant”, an “owner”, a “skier”, or variously hyphenated combinations of these terms. It will be understood that all such terms refer to that human who, at time and from time to time, may have a varying relationship to the para-alpine ski of the present invention.

2. A Para-Alpine Ski, Particularly a Dual-Runner Sit-Ski, Selectively Controllably Elevating its Seat

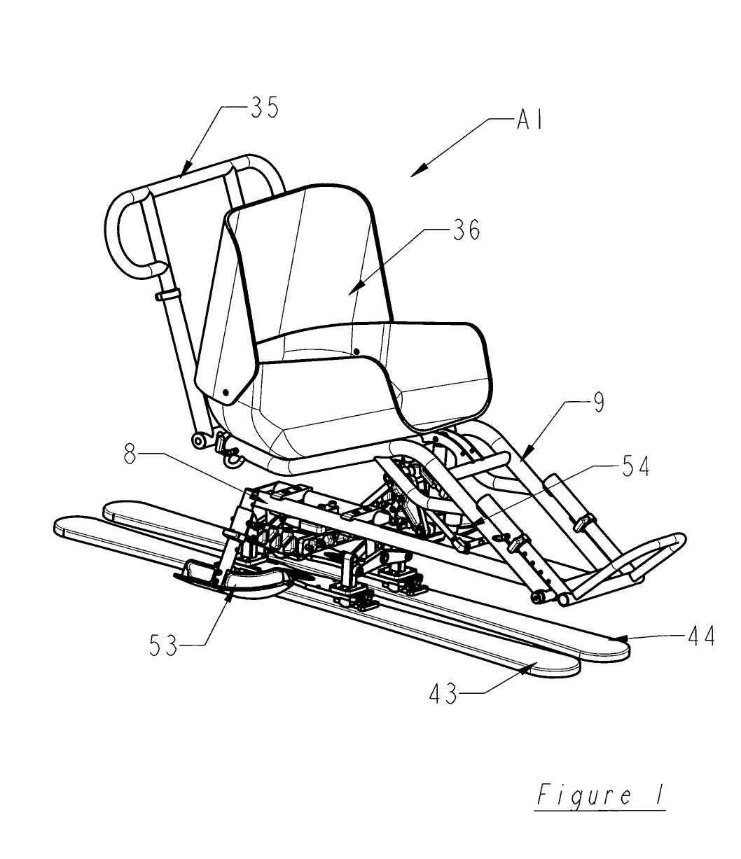

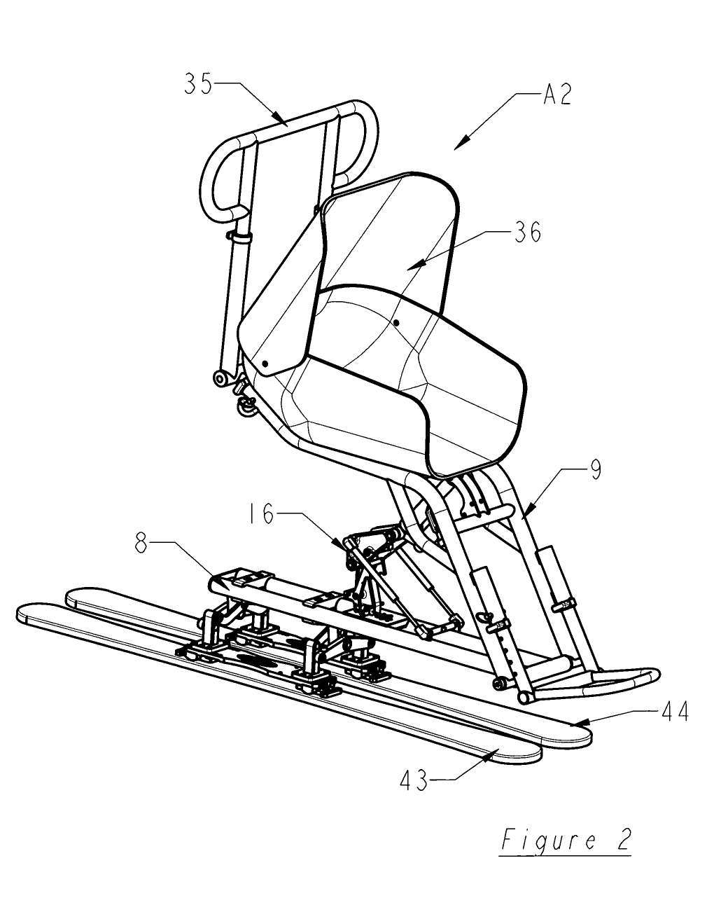

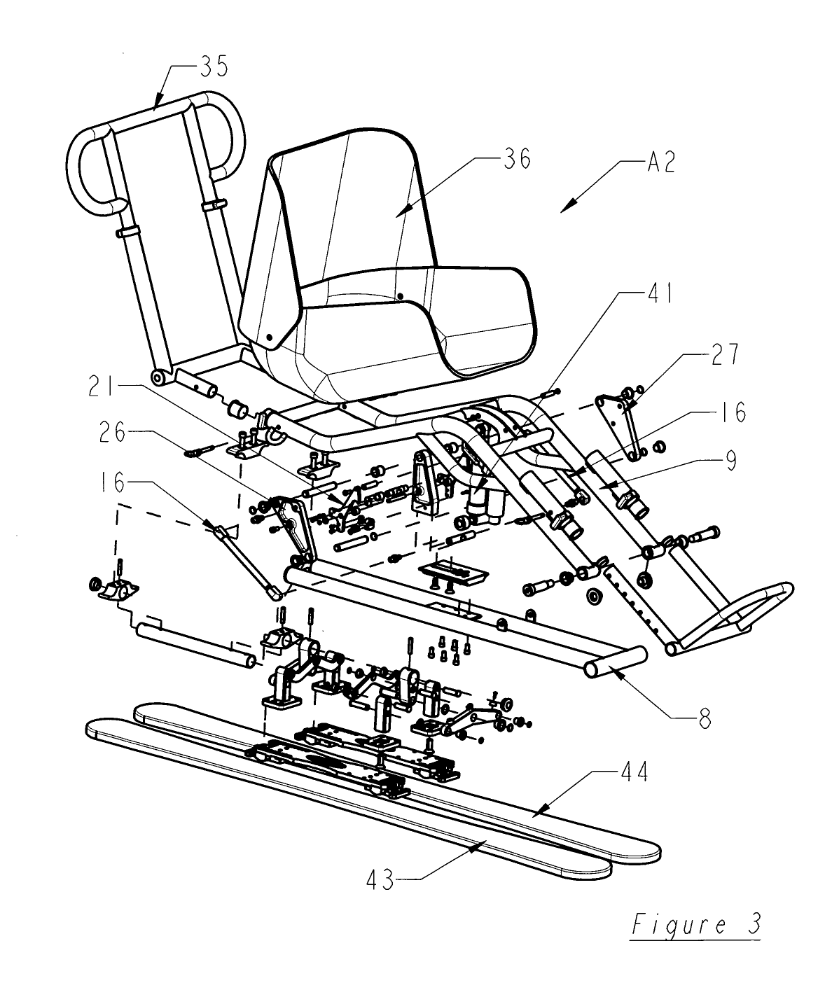

An exploded perspective view of preferred embodiments of a para-alpine sit skis A1, A2 with a mechanism to elevate its seat and its owner-user-skier-occupant upon the seat 36, in accordance with the present invention is shown in FIGS. 1-3. Embodiment A1 of FIG. 1 has optional outrigger skis and ski mechanisms 43, 44. These advanced mechanisms, and the use and selective attachment of outrigger skis is further explained in the companion patent application of even date for a PARA-ALPINE SIT-SKI WITH INDEPENDENTLY QUICK-DETACHABLE AND RE-ATTACHABLE (1) OUTRIGGER SKIS, AND/OR (2) A “ROLL BAR” FOR GUIDANCE. The embodiment A2 of FIGS. 2 and 3 does not have these optional outrigger skis.

The hinged clamshell high-bed seat 36 shown in FIGS. 1-3 is also of advanced form, and is the subject of a companion patent application of even date for a WHEELCHAIR WITH MULTIPLE REPLACEABLE SEATS. The contents of both applications are incorporated by reference.

In FIG. 3 and other figures the assigned identification numerals within the first column of the following table serve to designate those parts that are described within the second column, with the number of such parts used within the complete wheelchair being given in the third column:

In both figures the identification numerals within the first column of the following table are assigned to the respective parts that are described within the second column, with the number of such parts used within the complete wheelchair being given in the third column:

TABLE OF PARTS

| IDENTI- | | |
|---|---|---|
| FICATION | | QUAN- |
| NUMBER | DESCRIPTION | TITY |
| A1 | PARA-ALPINE SIT-SKI BI-SKI | 1 |
| | WITH OPTIONAL OUTRIGGER SKIS | |
| A2 | PARA-ALPINE SIT-SKI BI-SKI | 1 |
| | WITHOUT OPTIONAL | |
| | OUTRIGGER SKIS | |
| 8 | BI-SKI LOWER FRAME | 1 |
| 9 | BI-SKI UPPER FRAME | 1 |
| 16 | GAS SPRING, M6 THREAD, | 2 |
| | 8.35 L × 3.15 | |
| 26 | LOAD LINK LEFT | 1 |
| 27 | LOAD LINK RIGHT | 1 |
| 35 | ROLL BAR | 1 |
| 36 | SEAT | 1 |
| 41 | SHOCK ABSORBER | 1 |
| 43 | SKI, LEFT | 1 |
| 44 | SKI, RIGHT | 1 |
| 53 | RIGHT OUTRIGGER SKI | 1 |
| 54 | LEFT OUTRIGGER SKI | 1 |

A complete table of parts, including additional parts not identified by numbers in the drawings, that may be used in the construction is as follows.

COMPLETE TABLE OF PARTS

| DESCRIPTION | QUANTITY |
|---|---|
| ½″ SHAFT, 17-4PH SS | 2 |
| 1/4-20 × 3/4 FHCS | 2 |
| ARTICULATING FOOT, SUB-ASM | 2 |
| BALL JOINT, MCM 9512K73 | 4 |
| BHCS 10-24 × 1 SS | 1 |
| BHCS 10-32 × 1/4 SS | 2 |
| BHCS, 6-32 × .375 | 2 |
| BI-SKI FRAME, LOWER | 1 |
| BI-SKI FRAME, UPPER | 1 |
| CABLE MOUNT | 1 |
| COILED SPRINGPIN, 420 SS, .25 × 1.25 | 4 |
| FLOATING BINDING, SUB-ASM | 2 |
| FOOTREST | 1 |
| FOOTREST CAP | 4 |
| FRONT PIVOT BUNG | 2 |
| GAS SPRING, M6 THREAD, 8.35 L × 3.15 | 2 |
| IGUS MFI-0405-02 | 2 |
| IGUS MSI-0709-08 | 2 |
| IGUS QFI-0809-08-1 | 4 |
| IGUS QFI-1012-08-1 | 4 |
| LATCH LINK | 2 |
| LATCH PULL BLOCK | 1 |
| LATCH SHAFT | 1 |
| LATCH STOP BLOCK | 1 |
| LOAD LINK LATCH SPACER | 1 |
| LOAD LINK LEFT | 1 |
| LOAD LINK RIGHT | 1 |
| LOAD LINK SPACER | 2 |
| LOAD SPACER | 2 |
| LOWER FOOT CLAMP | 2 |
| LOWER FRAME, MOUNTING PLATE | 1 |
| LOWER FRAME, UPRIGHT | 1 |
| NYLON BALL-SOCKET, M6, MCM 9416K86 | 4 |
| QR PIN, 316 SS, 1/4 × 1-1/4 | 2 |
| ROLL BAR | 1 |
| SEAT | 1 |
| SHCS 4-40 × ½ | 2 |
| SHCS 1/4-20 × ½ | 8 |
| SHCS 5/16-18 × 1 | 4 |
| SHOCK ABSORBER | 1 |
| SHOCK SHAFT, UPPER | 1 |
| SHOULDER SCREW 5/8 × 1-3/4 SS | 2 |
| SKI, LEFT | 1 |
| SKI, RIGHT | 1 |
| SMALLEY WSM-25 SS | 2 |
| SMALLEY WST-50 | 4 |
| SPACER, MCM 94639A570 | 2 |
| SPRING MOUNT SPACER | 1 |
| THREAD FORMING SCREW, 6-19 | 4 |
| TORQUE TUBE | 1 |
| TUBE SLEEVE, NO SLOT | 4 |
| TUBE SLEEVE, SLOTTED | 2 |

In use of the sit-ski bi-skis A1, A2 of FIGS. 1 and 2 the owner-user (not shown) sits upon the SEAT 36. If another person (not shown) is guiding the bi-ski then he/she may stand upon the rear of the LEFT SKI 43 and the RIGHT SKI 44, and hold and manipulate the ROLL BAR 35, which also serves as a roll bar. This person (not shown) may also stand upon the ground to provide a limited force to push the bi-ski and its occupant (not shown) via the ROLL BAR 35.

Of particular importance to the present invention the two GAS SPRINGs 16 act between unmoving lower portions of the frame; namely, between the BI-SKI LOWER FRAME 8, and first rotatable members, namely, LOAD LINK LEFT 26 AND LOAD LINK RIGHT 27, serving as first bell cranks. These LOAD LINKS 26, 27 act between the LOWER FRAME 8 and the UPPER FRAME 9 as a bell crank to raise (and lower) the SEAT 36 of the bi-ski.

The substantial force to realize this rotation of the LOAD LINKS 26, 27 acting as bell cranks and the further elements to which they are linked in order to raise the SEAT 36 and its occupant (not shown) is provided by the preset charge in the GAS SPRINGS 16, which SPRINGS 16 are gas charged to provide a strong extension force along the UPPER SHOCK SHAFT 41.

One way of interpreting the coaction between parts of the para-alpine sit-ski illustrated in FIGS. 1-3 is to consider that the LOWER BI-SKI FRAME 8 and still lower elements including the skis 43, 44 collectively comprise a “lower frame”. Meanwhile, the UPPER BI-SKI FRAME 9 and still higher elements collectively comprise an “upper frame”. The parts and mechanisms in between this “lower” and this “upper” frame, particularly including the GAS SPRINGS 16, constitute the means by which the “upper frame”, and its SEAT 36, are selectively controllably elevated above, and (at other times) retracted towards, the “lower” frame and its SKIS 43, 44.

In particular, the cylindrical outer body of the cylindrical GAS SPRING 16 is rigidly mounted to the LOWER FRAME 8. The other end of the GAS SPRING 16 is its plunger, and this is mounted to the UPPER FRAME 9. Now this upper mounting is constrained by parts upon the lower frame so that when the GAS SPRING 16 is compressed, and its plunger withdrawn within its body, then either this plunger nor anything connected to its shaft can rotate, fixing the SEAT 36 in position (in all three dimensions) when the UPPER FRAME 9 is withdrawn down and into contact with the LOWER FRAME 8. However, then the UPPER FRAME 9 is raised then so also is the shaft of the plunger of the GAS SPRING 16 extended outwards and upwards, escaping the mechanical confines of the LOWER FRAME 8.

In accordance with the attachment of the UPPER FRAME 9 to this (upwards extending) shaft of the plunger of the GAS SPRING 16, the UPPER FRAME 9 including the FOOTREST 13 and the SEAT 36, is permitted to tilt both fore and aft. As previously explained, this tilting motion which is controlled by the body motion of the user-skier occupant of the sit-ski (not shown), permits the user-skier to sit down smoothly upon the chair of a chair lift, the LOWER FRAME 8 being slung underneath the chair. When the user-skier and the sit-ski unload from the chair lift at the top of the ski lift then the user-skier tilts forward from the chair of the chair lift, exits the chair, and, while skiing down the exit slope, plunges downward to re-seat the UPPER FRAME 9 to the LOWER FRAME 8 and to simultaneously re-lock the SEAT 36.

In use the owner-user (not shown) occupying the SEAT 36 releases with his right hand and fingers the LATCH LINK 21, freeing the bell crank mechanism involving the LEFT, and the RIGHT LOAD LINKs 26, 27 to rotate under force of GAS SHOCK 16 and raise the SEAT 36 and its occupant. The forces are present so that the owner-user (not shown) occupying the SEAT 36 must provide a little upwards force on his/her own, normally by thrusting downwards with hand-held outriggers (poles tipped with small skis) held in each hand, and normally at a location where, and at a time when, the chair lift of the ski slope is to be entered. A reasonably strong, capable and coordinated user-owner can normally do this entirely upon his/her own, and without assistance. If other persons positioned at one, or at both sides, of the owner-occupant wish to assist the owner occupant in rising, and in boarding the chair lift, then but a slight upwards and/or stabilizing force is normally sufficient, the present invention making it entirely unnecessary that the owner occupant and the sit-ski should be lifted into the chair lift either together or separately.

When the owner-occupant still seated aboard the SIT-SKI A, A1 reaches the top of the chair, and the disembarkation slope of the chair lift, then the unloading procedure remains, as in the past, somewhat brusque and precipitous (as it might be argued to be for all skiers). Namely, the disabled para-alpine skier aboard the sit-ski thrusts off the chair lift onto the disembarkation slope, creating a considerable force that, at the bottom of the short chair lift unloading and disembarkation slope, forces the sit-ski back into a lowered position, and compresses the GAS SHOCK 16. The owner-occupant re-positions the LATCH LINK 21, and locks the entire mechanism in the down position for ensuing skiing.

According to these variations, and still others within the skill of a practitioner of the para-alpine ski design arts, the present invention should be considered in accordance with the following claims, only, and not solely on accordance with those embodiments within which the invention has been taught.

What is claimed is:

1. A para-alpine ski comprising:
a seat upon which sets a user/skier;
a mechanism permitting the user/skier is to permit the seat to raise to a height sufficient so that a carry chair of a standard ski-slope chair lift can slip under the seat, and under the user who remains seated upon the seat, therein to capture the seat, the seated user and the entire para-alpine ski onto the ski-lift chair and to further convey both the user/skier and the para-alpine ski up a ski slope;
wherein the user/skier of this raising-seat para-alpine ski can assume a position seated upon an operating conventional ski slope ski-lift without external assistance from other humans or other machines if needs be.

2. The para-alpine ski according to claim 1
wherein the mechanism serving to raise the seat of the para-alpine ski upon which seat sets the user/skier is adjustable in its force so provided to raise the user/skier.

3. The para-alpine ski according to claim 1
wherein the mechanism serving to raise the seat of the para-alpine ski upon which seat sets the user/skier permits the seat to tilt fore and aft in a vertical plane along a longitudinal axis of the para-alpine ski.

4. The para-alpine ski according to claim 3
wherein the mechanism serving to raise the seat of the para-alpine ski so permits the seat to tilt only when in its raised position.

5. The para-alpine ski according to claim 1 wherein the mechanism serving to raise the seat comprises:
a gas spring.

5. The para-alpine ski according to claim 1
wherein the para-alpine ski is of the sit-ski type, with two ski runners.

7. The para-alpine ski according to claim 1
wherein the para-alpine ski is of the mono-ski type, with a single ski runner.

8. A para-alpine ski comprising:
at least one ski runner;
a seat upon which sets a user/skier;
a spring mechanism, pre-loaded to the substantial weigh of the user/skier and located between the at least one ski runner and the seat, controllable by the user/skier to elevate the seat and the user/skier upon the seat in elevation sufficient so that a carry chair of a standard ski-slope chair lift can slip under the seat, and under the user who remains seated upon the seat, therein to permit that the seat, the seated user and the entire para-alpine ski can be captured onto the moving chair a ski-lift chair and can be further conveyed up a ski slope;
wherein the user/skier of this raising-seat para-alpine ski can assume a position seated upon an operating conventional ski slope ski-lift without external assistance from other humans or other machines if needs be.

9. The para-alpine ski according to claim 8
wherein the spring mechanism serving to raise the seat of the ski upon which sets the user/skier is adjustable in its force so provided to raise the user/skier.

10. The para-alpine ski according to claim 8
wherein the spring mechanism serving to raise the seat of the ski upon which sets the user/skier permits the seat to tilt in its raised position.

11. The para-alpine ski according to claim 8
wherein the para-alpine ski is of the sit-ski type, with two ski runners.

12. The para-alpine ski according to claim 8
wherein the para-alpine ski is of the mono-ski type, with a single ski runner.
